(19) United States
(12) Patent Application Publication
(10) Pub. No.: US 2024/0319006 A1
(43) Pub. Date: Sep. 26, 2024

(54) SERIAL ARRAY OF MODULATORS AND DETECTORS

(71) Applicant: University of Central Florida Research Foundation, Inc., Orlando, FL (US)

(72) Inventor: Guifang Li, Orlando, FL (US)

(21) Appl. No.: 18/615,915

(22) Filed: Mar. 25, 2024

Related U.S. Application Data
(60) Provisional application No. 63/454,411, filed on Mar. 24, 2023.

(51) Int. Cl. G01J 1/42; G01J 1/44; G02F 1/01; G02F 1/015

(52) U.S. Cl. CPC G01J 1/4228; G01J 1/44; G02F 1/0121; G02F 1/015

(57) ABSTRACT

An optical receiver may include multiple photodetectors connected in serial and an amplifier connected to the photodetectors, where the amplifier is configured to amplify an electrical signal generated by the photodetectors in response to illumination. The receiver may further include one or more optical elements to receive signal light and direct the signal light to a subset of the plurality of photodetectors. The receiver may further include an illumination source to illuminate the plurality of photodetectors with flood illumination during operation. An optical modulator may include multiple modulators connected in serial and driven by a common voltage driver.

### CROSS-REFERENCE TO RELATED APPLICATION

The present application claims the benefit under 35 U.S.C. § 119(e) of U.S. Provisional Application Ser. No. 63/454,411, filed Mar. 24, 2023, entitled SERIAL ARRAY OF MODULATORS AND DETECTORS, naming Guifang Li as inventor, which is incorporated herein by reference in the entirety.

### TECHNICAL FIELD

The present disclosure relates generally to a receiver for a free-space optical communications system and, more particularly, to a receiver using flood illumination of a serial array of photodetectors.

### BACKGROUND

Currently, military systems use wireless communication for most applications. However, there are several limitations with this approach, namely, congested RF spectrum resulting in inferences that degrade the communication link; expensive for high bandwidth requirements and delivery; and restrictions on using unlicensed bands. Moreover, there is increasing need for more dynamic applications with high mobility along with high bandwidth communications. In addition, these applications attach a stringent constraint on size, weight, and power (SWAP) requirements.

Free space optics (FSO) systems offer an alternate solution for these applications. FSO communication can provide an orders-of-magnitude increase in capacity while reducing the antenna size thus SWAP in comparison with radio-frequency (RF) communication systems. There are no issues related to spectrum licensing as they operate in unregulated wavelength bands. Further, they use lasers that are very directional, thus avoiding interference from neighbors, provide security for the user. The focusing capability of optical antennas, an advantage in terms of the required antenna size, also directly lead to several challenges for FSO communication. The directivity and security mentioned above result directly in the requirements for high-precision beam pointing and tracking. As a result, commercial FSO systems available today are generally fixed point-to-point systems with very little mobility. Another serious challenge for FSO communication is maintaining a reliable communication link under turbulent atmospheric conditions. In aggregate, the performance, cost and size of current FSO systems make them impractical for use in dynamic and mobile applications.

One critical component in an FSO receiver is a photodetector. The bandwidth of the photodetector is limited by its RC time constant, where R is its series resistance and C is its capacitance. The other factor that limits the bandwidth is the transit time of the photogenerated carriers across the absorption region, but this time constant is generally a secondary effect. The capacitance of the photodetector is primarily determined by its area. Larger area will allow for detection over wider incident angle or larger beam size, but unfortunately at the expense of reduced bandwidth, resulting in a trade-off. A lens system can be used to focus a large beam onto a small area photodetector, but then the physical law of etendue will result in a decreased FoV.

There is therefore a need to develop systems and methods to address the above deficiencies.

### SUMMARY

In embodiments, the techniques described herein relate to an optical receiver including a plurality of photodetectors connected in serial; an amplifier connected to the plurality of photodetectors, where the amplifier is configured to amplify an electrical signal generated by the plurality of photodetectors in response to illumination; one or more optical elements configured to receive signal light and direct the signal light to a subset of the plurality of photodetectors; and a light source configured to illuminate the plurality of photodetectors with flood illumination.

In embodiments, the techniques described herein relate to an optical receiver, where the one or more optical elements are configured to direct the signal light to a single one of the plurality of photodetectors.

In embodiments, the techniques described herein relate to an optical receiver, where the flood illumination uniformly illuminates the plurality of photodetectors.

In embodiments, the techniques described herein relate to an optical receiver, where an average power of the flood illumination is selected to be greater than or equal to an average power of the signal light.

In embodiments, the techniques described herein relate to an optical receiver, further including a plurality of resistors, where each of the plurality of photodetectors is connected in parallel with a different one of the plurality of resistors.

In embodiments, the techniques described herein relate to an optical receiver, where the plurality of photodetectors are arranged in a linear distribution.

In embodiments, the techniques described herein relate to an optical receiver, where the plurality of photodetectors are arranged in at least one of a rectangular distribution or a square distribution.

In embodiments, the techniques described herein relate to an optical receiver, where the plurality of photodetectors are arranged in at least one of an elliptical distribution or a circular distribution.

In embodiments, the techniques described herein relate to an optical receiver, where the plurality of photodetectors include at least one of photodiodes or avalanche photodiodes.

In embodiments, the techniques described herein relate to an optical receiver, where the amplifier includes a trans-impedance amplifier.

In embodiments, the techniques described herein relate to a modulator including a plurality of modulators connected in series; and a voltage driver to drive the plurality of modulators.

In embodiments, the techniques described herein relate to a modulator, where the plurality of modulators include PN junctions.

In embodiments, the techniques described herein relate to a modulator, where the plurality of modulators include capacitors.

In embodiments, the techniques described herein relate to a modulator, where the plurality of modulators are formed from at least one of silicon, lithium niobate, or barium titanate.

In embodiments, the techniques described herein relate to a modulator, where at least some of the plurality of modulators include a travelling-wave modulator.

In embodiments, the techniques described herein relate to a modulator, where at least some of the plurality of modulators include a ring modulator.

In embodiments, the techniques described herein relate to a modulator, further including two or more cascaded modulator devices, where each of the two or more cascaded modulator devices is formed form two or more of the plurality of modulators.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1 is a block diagram of an optical receiver, in accordance with one or more embodiments of the present disclosure.

FIG. 2A is a simplified schematic of an optical receiver, in accordance with one or more embodiments of the present disclosure.

FIG. 2B is a is a simplified schematic of an optical receiver with a rectangular array of photodetectors, in accordance with one or more embodiments of the present disclosure.

FIG. 2C is a is a simplified schematic of an optical receiver with an elliptical array of photodetectors, in accordance with one or more embodiments of the present disclosure.

FIG. 3 is a simplified schematic of modulator device, in accordance with one or more embodiments of the present disclosure.

FIG. 4 is a simplified schematic of a modulator device including PN junction modulators connected in series, in accordance with one or more embodiments of the present disclosure.

FIG. 5 is a simplified schematic of a travelling-wave modulator, in accordance with one or more embodiments of the present disclosure.

FIG. 6A is a simplified schematic of a travelling-wave modulating element incorporating a modulator device with series modulators, in accordance with one or more embodiments of the present disclosure.

FIG. 6B is a simplified schematic of a travelling-wave modulator incorporating multiple cascaded travelling-wave modulating elements, in accordance with one or more embodiments of the present disclosure.

FIG. 7 is a simplified schematic of a ring modulator including two series modulators, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods for utilizing a group of optical modulator elements and/or optical receiver elements in series to provide high-bandwidth operation while minimizing tradeoffs with other key parameters.

It is well known that the speed of first-order electronic circuits is limited, in general, by the RC (resistor-capacitor) time constants. Most of the optical modulators and photodetectors can be modeled, mostly, as a capacitor. It is also well known that two capacitors in series (e.g., serially connected) have an equivalent capacitance smaller than either of the two (half if two capacitors are identical). Disclosed herein are arrays of modulators and detectors, connected in series, so as to enhance the bandwidth of modulations and detection, without sacrificing other performance metrics.

In some embodiments, an optical receiver includes an array of photodetectors connected in series, where the photodetectors are uniformly illuminated by flood illumination (e.g., continuous-wave (CW) illumination) during operation, and where a subset of the photodetectors (e.g., a single photodetector) is illuminated with the signal light during operation. It is contemplated herein that such a configuration may be well-suited for, but not limited to, a receiver of a free-space optical communications (FOC) system. In particular, this configuration may beneficially provide a field of view (FOV) determined by an area of the array of photodetectors, high-bandwidth operation due to the serial connections of the photodetectors, and high sensitivity to the signal light due to the flood illumination of the entire array of photodetectors.

In some embodiments, an optical modulator includes a group (e.g., an array) of PN junction modulators connected in series and driven by a common driving voltage. In this configuration, the length of the entire modulator is increased by a factor of N and the equivalent capacitance of the entire modulator is decreased by a factor of N, in comparison with a modulator unit with a single PN junction modulator. As a result, the modulator array will decrease a value of V_{π} by a factor of N because of the N time the length, and increase its bandwidth by a factor of N because of N times reduction in capacitance.

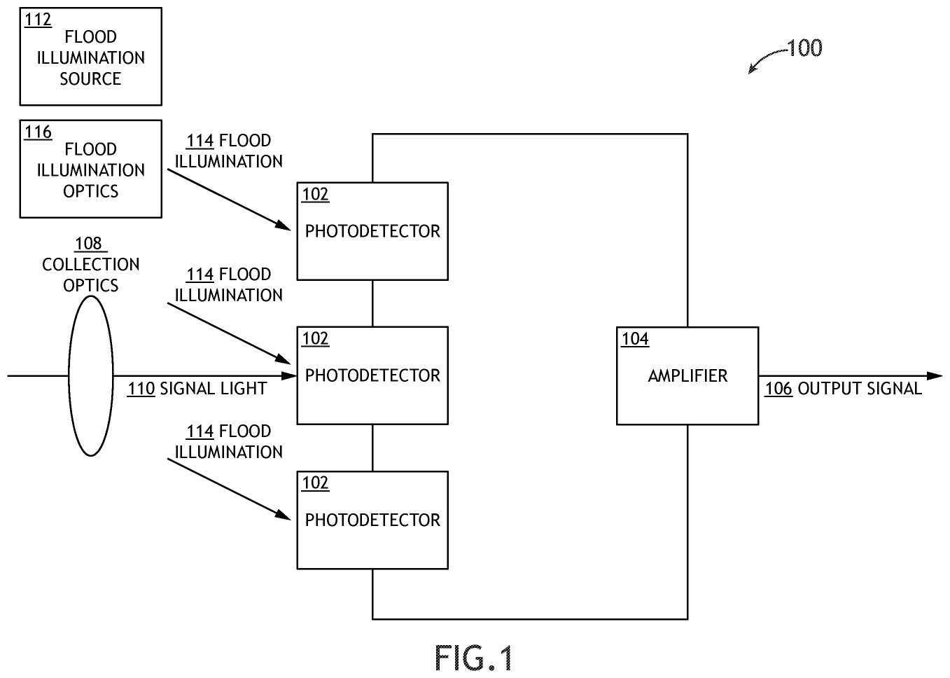

FIG. 1 is a block diagram of an optical receiver 100, in accordance with one or more embodiments of the present disclosure.

In some embodiments, the optical receiver 100 includes multiple photodetectors 102 arranged in a serial distribution and an amplifier 104 to amplify an electrical signal from the serially-connected photodetectors 102 to generate an output signal 106 (e.g., an output electrical signal). For example, FIG. 1 depicts three photodetectors 102, though it is to be understood that the optical receiver 100 may include any number of serially-connected photodetectors 102. The photodetectors 102 may include any type of sensor suitable for detecting light and generating an electrical signal based on the detected light. For example, a photodiode 102 may include a photodetector, an avalanche photodetector (APD), or the like. Further, although not explicitly shown, the optical receiver 100 may include one or more resistors connected in parallel with the photodetectors 102. Such resistors may further reduce the resistance of the array of photodetectors 102 and increase the bandwidth of the optical receiver 100.

In some embodiments, the optical receiver 100 includes one or more collection optics 108 configured to receive signal light 110 and direct the signal light 110 to a subset of the photodetectors 102. For example, the collection optics 108 may direct the signal light 110 to a single photodetector 102.

The signal light 110 may include any type of modulated light from any source having at least some alternating current (AC) component (e.g., an AC signal). For example, the signal light 110 may be modulated with data using any modulation technique known in the art providing at least some AC signal. In some embodiments, the signal light 110 is generated from a FOC transmitter such that the optical receiver 100 may operate as an FOC receiver.

The amplifier 104 may include any component or combination of components suitable for amplifying the electrical signal generated by the photodetectors 102. For example, the amplifier 104 may amplify at least the AC component of the electrical signal from the array of photodetectors 102 associated with the AC component of the signal light 110. In some embodiments, the amplifier 104 includes a trans-impedance amplifier (TIA). In some embodiments, the amplifier 104 provides multiple amplification stages. For example, the amplifier 104 may include a one or more pre-amplification stages and one or more power amplification stages.

The collection optics 108 may include any number of optical elements suitable for collecting the signal light 110 and directing the signal light 110 to a subset of the photodetectors 102. For example, the collection optics 108 may include one or more lenses or mirrors (e.g., flat or curved mirrors) to collect and focus the signal light 110 onto a subset of the photodetectors 102.

In some embodiments, the optical receiver 100 includes a flood illumination source 112 to generate flood illumination 114 and flood illumination optics 116 to illuminate the array of photodetectors 102 with the flood illumination 114. In some embodiments, the flood illumination 114 is CW illumination. It is noted that FIG. 1 does not depict beam paths of the flood illumination 114 for clarity and is intended merely for illustration.

The flood illumination source 112 may include any type of light source suitable for generating flood illumination 114 such as, but not limited to, a laser source or a light-emitting diode (LED). The flood illumination optics 116 may include any number of optical elements suitable for collecting the flood illumination 114 and directing the flood illumination 114 to the photodetectors 102 such as, but not limited to, one or more lenses or mirrors.

In some embodiments, a power of the flood illumination 114 is selected to be greater than or equal to a power of the signal light 110 (e.g., an average power of the signal light 110, or the like). In this way, the AC component of the signal light 110 may be maximally detected and captured by the associated electrical signals generated by the photodetectors 102 and amplified by the amplifier 104.

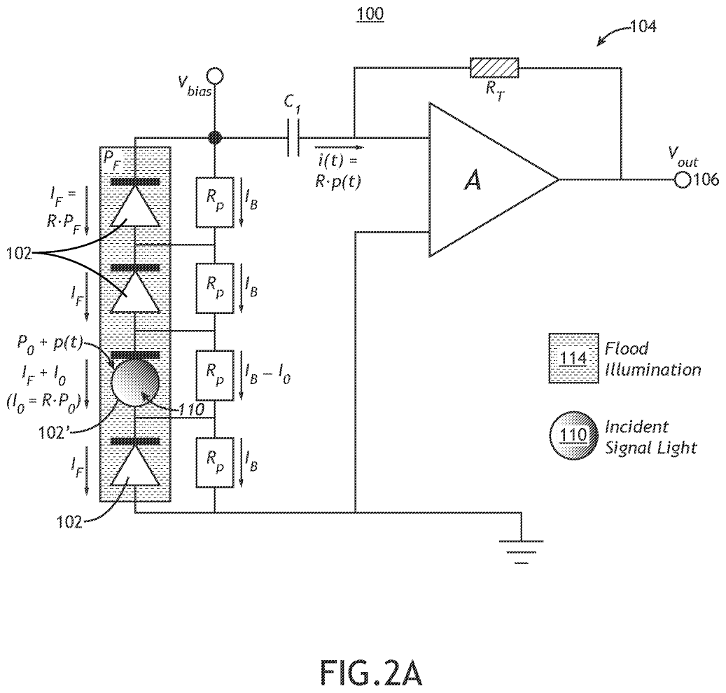

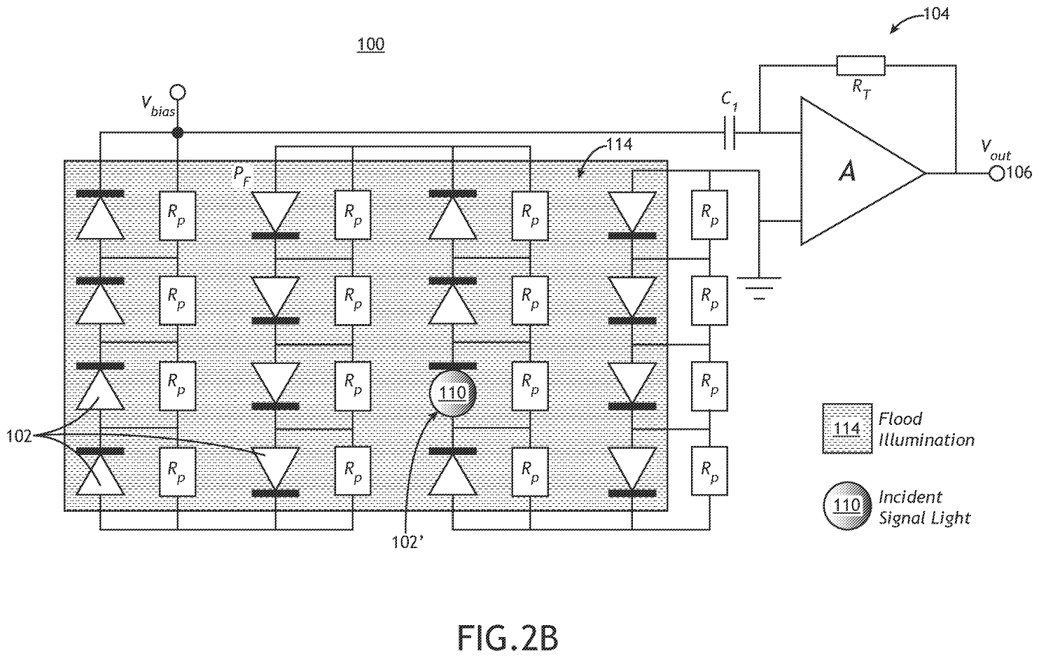

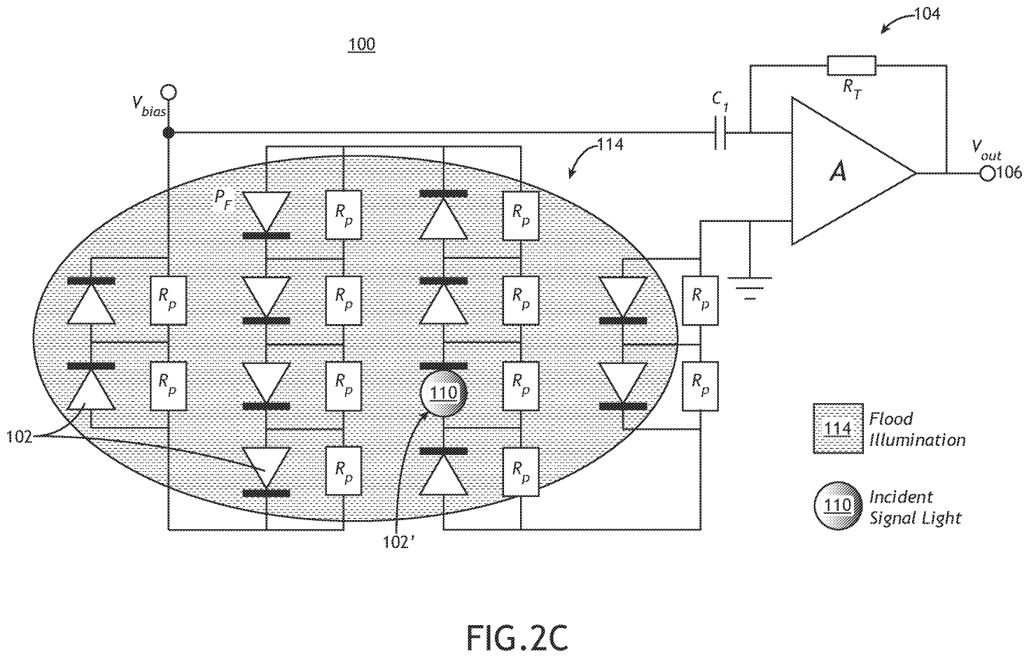

FIG. 2A is a simplified schematic of an optical receiver 100, in accordance with one or more embodiments of the present disclosure. In FIG. 2A, the optical receiver 100 is depicted with four serially-connected photodetectors 102 and of resistors (R_{P}) connected in parallel with the photodetectors 102. The amplifier 104 is depicted as a trans-impedance amplifier with a series capacitor (Cᵢ) and a feedback resistor (R_{T}). Additionally, voltage bias (V_{bias}) and ground connections are illustrated.

In this configuration, a flood current (I_{F}) associated with flood illumination 114 incident on all photodetectors 102 may be characterized as I_{F}=R·P_{F}, where R is the responsivity of a photodetector 102 and P_{F} is a power of the flood illumination 114. A signal current (I₀) associated with signal light 110 incident on a single photodetector 102′ may be characterized by I₀=R·P₀, where R is again the responsivity of the associated photodetector 102′ and P₀ is the power of the signal light 110. This results in a total current through the photodetector 102′ of I_{F}+I₀.

The power of the modulated signal light 110 may be characterized by Pₒ+p(t), where Pₒ is a DC component and p(t) is a time-varying (e.g., AC) component. Accordingly, the current propagating through the series capacitor Cᵢ may then be written as i(t)=R·p(t). It is contemplated herein that this configuration in which the signal light 110 is incident on a single photodetector 102′ and flood illumination 114 is incident on all photodetectors 102 provides the maximum AC photocurrent i(t) while retaining the high-bandwidth performance of the serially-connected photodetectors 102.

It is noted that the photodetectors 102 may be physically arranged in any suitable distribution while maintaining logical series connections. As an illustration, the photodetectors 102 may be arranged in a square distribution, a rectangular distribution, a circular distribution, an elliptical distribution, a triangle distribution, a hexagonal distribution, or any other suitable distribution. For example, although FIG. 2A depicts a single linear array of photodetectors 102, this is merely illustrative and not limiting. FIG. 2B is a is a simplified schematic of an optical receiver 100 with a rectangular array of photodetectors 102, in accordance with one or more embodiments of the present disclosure. FIG. 2C is a is a simplified schematic of an optical receiver 100 with an elliptical array of photodetectors 102, in accordance with one or more embodiments of the present disclosure.

Further, it is emphasized that various elements depicted in FIGS. 2A-2C may be physically located in different planes. For example, the photodetectors 102 may be densely arranged in one plane while the resistors R_{P} and associated wiring may be on additional planes such that they do not obstruct incident light (e.g., signal light 110 and/or flood illumination 114) on the photodetectors 102.

The performance of the optical receiver 100 in the context of FOC is now described in greater detail, in accordance with one or more embodiments of the present disclosure. It is noted that the optical receiver 100 is not limited to FOC applications and that the descriptions below are merely for the purposes of illustration.

It is contemplated herein that efforts to increase the performance and capabilities of FOC systems have suffered from high power requirements, complexity, and/or undesirable tradeoffs between sensitivity and bandwidth.

Recently, photonic integrated circuits (PICs) have begun to address the FSO system requirements, particularly with respect SWAP. Since PICs based on silicon photonics (SiPh) exploit the large-scale manufacturing capabilities offered by several process foundries, any solution for FSO applications have a potential path towards large scale commercialization and therefore cost savings. PIC-based FSO systems have been demonstrated but with limitations. The most challenging component in the FSO systems is the receiver. It must be broadband, both in wavelength (spectrum) as well as speed to allow for high communication rates, and at the same time it must have large aperture to capture the incoming light signal over a wide angle. This is referred to as field-of-view (FoV), which covers both entry aperture as well as angular aperture. Large FoV significantly eases the alignment of the receiver to the beam, and maximizes the optical power captured in order to maximize the link budget.

Several efforts to increase the FSO receiver's aperture while preserving a high bandwidth are generally described in the following references, all of which are incorporated herein by reference in their entirety: Z. Zeng, M. D. Soltani, M. Safari, H. Haas, in ICC 2019-2019 IEEE International Conference on Communications (ICC). (IEEE, 2019), pp. 1-6; Z. Cao, L. Shen, Y. Jiao, X. Zhao, T. Koonen, in 2017 Optical Fiber Communications Conference and Exhibition (OFC). (IEEE, 2017), pp. 1-3; R. Winston, Dielectric compound parabolic concentrators. Applied optics 15, 291-292 (1976); K. Wang, A. Nirmalathas, C. Lim, K. Alameh, E. Skafidas, Full-duplex gigabit indoor optical wireless communication system with CAP modulation. IEEE Photonics Technology Letters 28, 790-793 (2016); A. Riaz, S. Collins, in 2020 European Conference on Optical Communications (ECOC). (IEEE, 2020), pp. 1-4; T. Koonen, K. Mekonnen, F. Huijskens, Z. Cao, E. Tangdiongga, in 2020 European Conference on Optical Communications (ECOC). (IEEE, 2020), pp. 1-4; and T. Koonen et al., Beam-Steered Optical Wireless Communication for Industry 4.0. IEEE Journal of Selected Topics in Quantum Electronics 27, 1-10 (2021).

However, existing techniques incorporating such a photodetector array typically suffer from relatively low sensitivity. For example, one approach to increasing the FoV of such a system is to increase a collection area of a photodetector, which may be achieved either using a single large-area photodetector or with an array of photodetectors. Approaches utilizing an array of smaller photodetectors may generally provide greater bandwidth than single-detector approaches, but still suffer from undesirable tradeoffs between sensitivity and bandwidth. Parallel connections between photodetectors may increase sensitivity (e.g., a signal to noise ratio (SNR) of generated photocurrent in response to incident signal light) but may limit the bandwidth since the capacitances of the photodetectors are added. Serial connections between photodetectors may increase the bandwidth since the overall capacitance of is reduced relative to a single photodetector, but the sensitivity may be limited since the photocurrent of a serial array of photodetectors is limited to the smallest photocurrent generated by any of the constituent photodetectors. As a result, illuminating the entire array with signal light in an effort to maximize the photocurrent generated by all serially-connected photodetectors requires splitting the power of the signal light across the photodetectors and thus limiting the photocurrent from each of the photodetectors. As an illustration, a photodetector array having K rows of photodetectors connected in parallel and M photodetectors serially connected in each row may provide 1/M of the total possible photocurrent that would be generated with a single photodetector. This presents a substantial photocurrent (e.g., sensitivity) tradeoff for high-bandwidth configurations with increasing M.

It is contemplated herein that the optical receiver 100 illustrated in FIGS. 1-2C does not suffer from the tradeoff between bandwidth and sensitivity described above. In particular, the optical receiver 100 includes photodetectors 102 connected in series to provide high-bandwidth operation due to the overall capacitance decrease relative to a single photodetector 102. Further, the uniform illumination of the photodetectors 102 with the flood illumination 114 combined with the illumination of just a subset of the photodetectors 102 (e.g., a single photodetector 102) with the modulated signal light 110 overcomes the sensitivity penalty of existing techniques (e.g., the 1/M reduction in photocurrent described above). For example, concentrating the signal light 110 onto a single photodetector 102 provides optimal photocurrent (e.g., the same photocurrent as would be generated with a single photodetector instead of the array), while the flood illumination 114 may have sufficient power to ensure that all of the serially-connected photodetectors 102 generate photocurrent and thus do not limit the overall photocurrent output of the array. As a result, both high-bandwidth and high sensitivity may be achieved. Further, the increased available collection area of the array of photodetectors 102 may also beneficially increase the FoV since the signal light 110 may be directed to any of the photodetectors 102 without impacting performance.

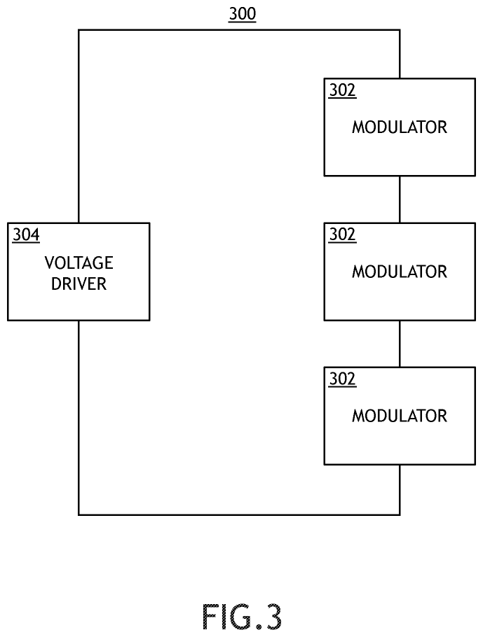

Referring now to FIGS. 3-XX, optical modulation with serially-connected modulator elements is described in greater detail, in accordance with one or more embodiments of the present disclosure. It is contemplated herein that an optical modulator may be formed from a PN junction (e.g., a diode) and that the teachings related to the optical receiver 100 may be extended to optical modulation.

FIG. 3 is a simplified schematic of modulator device 300, in accordance with one or more embodiments of the present disclosure. In some embodiments, the modulator device 300 includes a group of modulators 302 connected serially and a voltage driver 304 to provide a driving voltage. The voltage driver may include any component or combination of components providing voltage and/or current sufficient for driving the modulators 302 of the modulator device. In some embodiments, the voltage driver 304 is a static voltage source providing a static voltage required to drive the modulators 302. In some embodiments, the voltage driver 304 is a tunable voltage source that may provide an adjustable voltage suitable.

The modulators 302 may be any component or combination of components suitable for electro-optic modulation including, but not limited to, a PN junction. In this configuration, the length of the entire modulator device 300 is increased by a factor of N and the equivalent capacitance of the entire modulator device 300 is decreased by a factor of N in comparison with a single modulator 302. As a result, the modulator device 300 will decrease v, by a factor of N because of the length increase and further increase the bandwidth by a factor of N because of the capacitance reduction.

The modulators 302 may further be formed from any suitable materials including, but not limited to, silicon, lithium niobate, or barium titanate. It is contemplated herein that a silicon photonics approach may beneficially provide heterogeneous integration with other silicon-based devices, but this is not a limitation. Further, the modulator device 300 may generally have any suitable design in which the modulators 302 may be modeled as capacitors. For example, the modulator device 300 may generally form any type of electro-optic modulator, electro-absorption modulator, direct laser diode modulator, or the like.

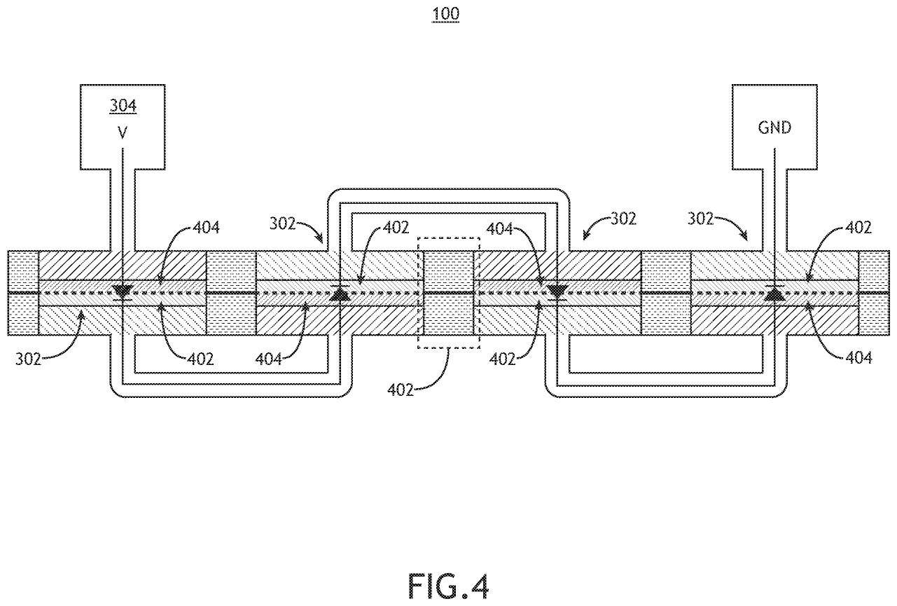

FIG. 4 is a simplified schematic of a modulator device 300 including PN junction modulators 302 connected in series, in accordance with one or more embodiments of the present disclosure. For example, in FIG. 4, the modulators 302 are arranged such that the cathode 402 of one modulator 302 is connected to the anode 404 of a subsequent modulator 302. FIG. 4 further depicts a passive ridge/rib waveguide 406.

Additional aspects of optical modulation with series modulator elements are now described in greater detail, in accordance with one or more embodiments of the present disclosure.

In the case of an optical modulator, there may be a tradeoff between drive voltage and modulation bandwidth and/or transit time for integrated optical modulators. This is because, although the driver voltage decreases with modulator length, the modulator bandwidth also decreases width modulator length.

One approach to circumventing this tradeoff incorporates a travelling-wave design. In this approach, a modulator is treated as a transmission line such that only the capacitance per unit length rather than the total capacitance of the modulator matters, provided that the group velocities of the optical wave and the driving microwave wave are matched. Unfortunately, matching the group velocities of optical waves and microwaves over a broadband cannot be perfect and this imposes practical limits to length of the modulator, and thus the drive voltage-modulation bandwidth tradeoff. For example, for silicon photonics, this tradeoff limits the modulation bandwidth of silicon modulators to roughly 35 GHz at CMOS compatible drive voltages.

However, incorporating travelling-wave modulators in a cascaded series design may overcome these limitations.

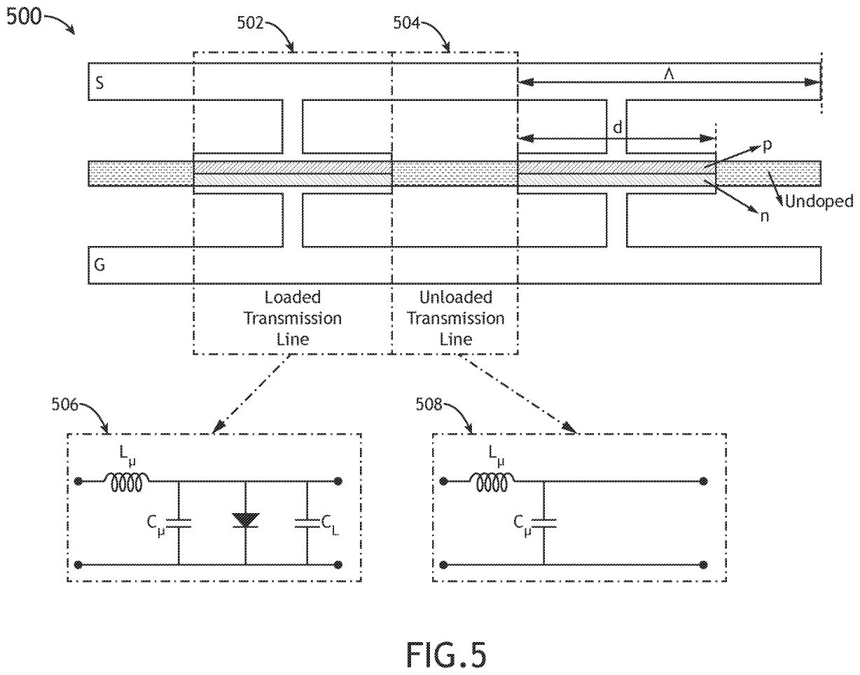

FIG. 5 is a simplified schematic of a travelling-wave modulator 500 (e.g., a travelling-wave Mach-Zender modulator (MZM), in accordance with one or more embodiments of the present disclosure. In particular, FIG. 5 depicts a configuration in which the travelling-wave modulator 500 includes loaded transmission line portions 502 and unloaded transmission line portions 504 in parallel between signal (S) and ground (G) terminals. Inset 506 depicts an equivalent circuit associated with a loaded transmission line portion 502. The impedance (Z₀) and optical group index (n₀) of the loaded transmission line portion 502 may be characterized as:

$${Z}_{0} = \sqrt{\frac{{L}_{μ}}{{C}_{μ} + {C}_{L}}} , \qquad ( 1 )$$

$${n}_{0} = c \sqrt{{L}_{μ} ( {C}_{μ} + {C}_{L} )} , \qquad ( 2 )$$

where c is the speed of light, L corresponds to inductance, and C corresponds to capacitance.

Inset 508 depicts an equivalent circuit associated with an unloaded transmission line portion 504. The impedance (Z₀) and optical group index (no) of the unloaded transmission line portion 504 may be characterized as:

$${Z}_{0} = \sqrt{\frac{{L}_{μ}}{{C}_{μ}}} , \qquad ( 3 )$$

$${n}_{0} = c \sqrt{{L}_{μ} {C}_{μ}} . \qquad ( 4 )$$

The use of unloaded transmission line portions 504 may be incorporated since the capacitance of loaded transmission line portions 502 may be higher than desired. For example, some current designs incorporate a 50% duty cycle between loaded transmission line portions 502 and unloaded transmission line portions 504. However, this may result in relatively long devices, which may negatively impact modulation speeds.

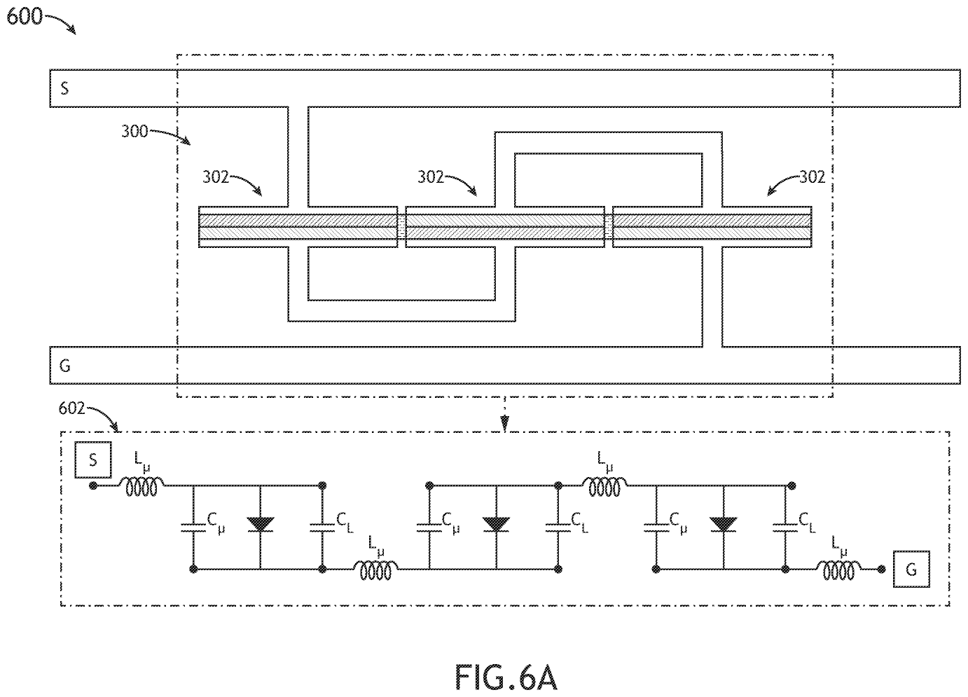

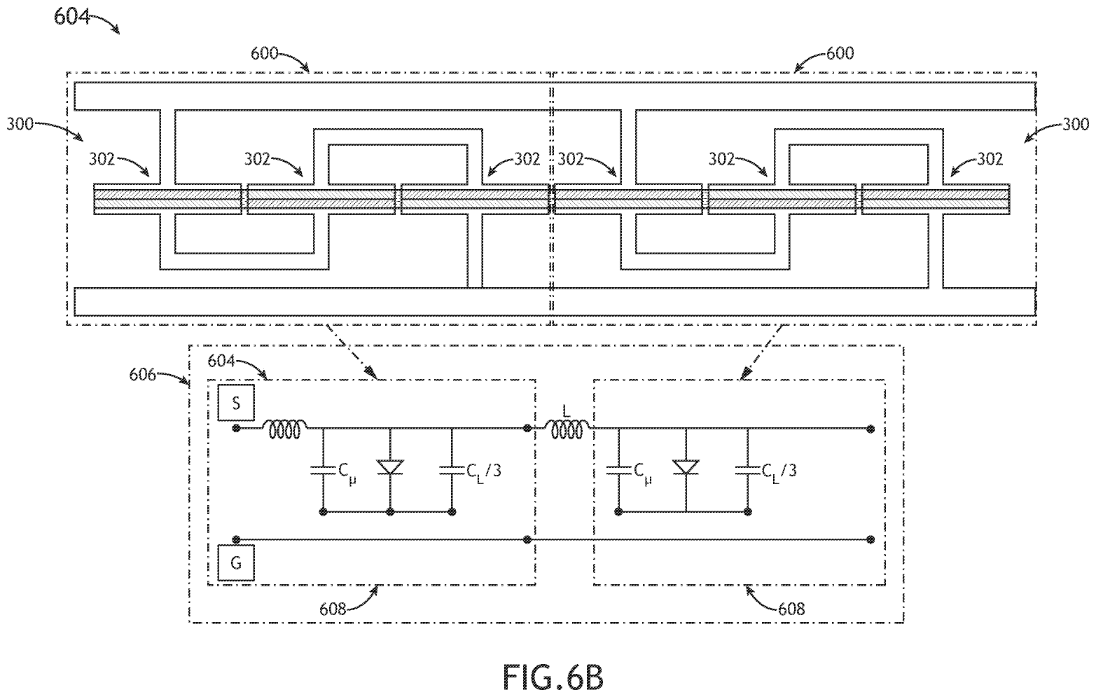

Referring now to FIG. 3 and FIGS. 6A-6B, it is contemplated herein that the modulators 302 may be provided as travelling-wave modulators (e.g., loaded transmission line modulators) that may be placed in series (e.g., periodically). This configuration may provide matching (e.g., perfect matching of the capacitance of the loaded transmission line modulators 302. It is noted that this configuration may require three times the drive voltage but one-third the current (e.g., compared to a non-serial configuration). Further, unloaded transmission line portions are not needed in this configuration. As a result, the use of series-connected travelling-wave modulator may advantageously provide a relatively small footprint, relatively higher speeds (e.g., double the speeds in some cases), and a reduced radio-frequency (RF) loss (e.g., on the order of 3 dB in some cases), and reduced insertion loss (e.g., compared to a non-serial configuration).

FIG. 6A is a simplified schematic of a travelling-wave modulating element 600 incorporating a modulator device 300 with series modulators 302, in accordance with one or more embodiments of the present disclosure. For example, FIG. 6A provides three series-connected modulators 302, which are arranged between signal (S) and ground (G) terminals. Inset 602 provides an equivalent circuit of the travelling-wave modulating element 600.

FIG. 6B is a simplified schematic of a travelling-wave modulator 604 incorporating multiple cascaded travelling-wave modulating elements 600, in accordance with one or more embodiments of the present disclosure. Inset 606 depicts an equivalent circuit of the travelling-wave modulator 604, where an equivalent circuit of a single travelling-wave modulator is further shown in boxes 608.

As depicted in FIGS. 6A-6B, a travelling-wave modulating element 600 with series-connected modulators 302 may have a similar equivalent circuit as a loaded transmission line portion 502, but where the capacitance term C_{L} from FIG. 5 is reduced by a number N of series-connected elements (e.g., replaced by C_{L}/3 for three series-connected modulators 302). The equations (1)-(2) for the impedance and optical group index may also be adjusted accordingly.

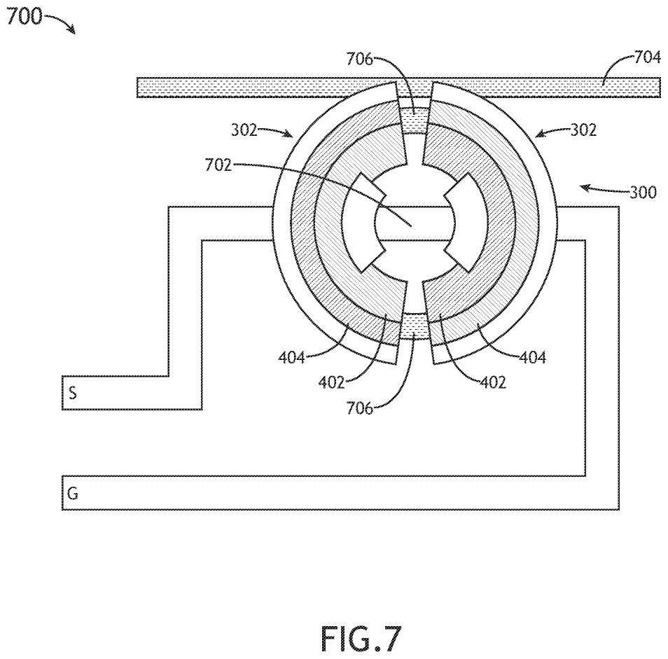

Referring now to FIG. 7, in some embodiments, series-connected modulators 302 may be provided as a ring modulator or a series of cascaded ring modulators. FIG. 7 is a simplified schematic of a ring modulator 700 including two series modulators 302, in accordance with one or more embodiments of the present disclosure. For example, FIG. 7 depicts the cathode 402 of one modulator 302 is connected to the anode 404 of a subsequent modulator 302, where the cathodes 402 and anodes 404 of the two modulators 302 are formed as a split ring design connected by conductive element 702. FIG. 7 further depicts an undoped bus waveguide 704 and undoped regions 706 between the modulators 302. Further, FIG. 7 depicts the two series modulators 302 between signal (S) and ground (G) terminals.

Although not shown, it is further contemplated herein that multiple ring modulators 700 may be, but are not required to be cascaded (e.g., in series).

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. An optical receiver comprising:
a plurality of photodetectors connected in serial;
an amplifier connected to the plurality of photodetectors, wherein the amplifier is configured to amplify an electrical signal generated by the plurality of photodetectors in response to illumination;
one or more optical elements configured to receive signal light and direct the signal light to a subset of the plurality of photodetectors; and
a light source configured to illuminate the plurality of photodetectors with flood illumination.

2. The optical receiver of claim 1, wherein the one or more optical elements are configured to direct the signal light to a single one of the plurality of photodetectors.

3. The optical receiver of claim 1, wherein the flood illumination uniformly illuminates the plurality of photodetectors.

4. The optical receiver of claim 1, wherein an average power of the flood illumination is selected to be greater than or equal to an average power of the signal light.

5. The optical receiver of claim 1, further comprising:
a plurality of resistors, wherein each of the plurality of photodetectors is connected in parallel with a different one of the plurality of resistors.

6. The optical receiver of claim 1, wherein the plurality of photodetectors are arranged in a linear distribution.

7. The optical receiver of claim 1, wherein the plurality of photodetectors are arranged in at least one of a rectangular distribution or a square distribution.

8. The optical receiver of claim 1, wherein the plurality of photodetectors are arranged in at least one of an elliptical distribution or a circular distribution.

9. The optical receiver of claim 1, wherein the plurality of photodetectors comprise at least one of photodiodes or avalanche photodiodes.

10. The optical receiver of claim 1, wherein the amplifier comprises:
a trans-impedance amplifier.

11. A modulator comprising:
a plurality of modulators connected in series; and
a voltage driver to drive the plurality of modulators.

12. The modulator of claim 11, wherein the plurality of modulators comprise:
PN junctions.

13. The modulator of claim 11, wherein the plurality of modulators comprise:
capacitors.

14. The modulator of claim 11, wherein the plurality of modulators are formed from at least one of silicon, lithium niobate, or barium titanate.

15. The modulator of claim 11, wherein at least some of the plurality of modulators comprise:
a travelling-wave modulator.

16. The modulator of claim 11, wherein at least some of the plurality of modulators comprise:
a ring modulator.

17. The modulator of claim 11, further comprising:
two or more cascaded modulator devices, wherein each of the two or more cascaded modulator devices is formed form two or more of the plurality of modulators.
